(19) United States
(12) Patent Application Publication
(10) Pub. No.: US 2008/0077547 A1
(43) Pub. Date: Mar. 27, 2008

(54) Method and an apparatus for identifying an instance of a variability meta-model and performing a product instantiation

(76) Inventor: Anil Kumar Thurimella, Munich (DE)

Correspondence Address: HARNESS, DICKEY & PIERCE, P.L.C., P.O.BOX 8910, RESTON, VA, 20195, US

(21) Appl. No.: 11/896,749

(22) Filed: Sep. 5, 2007

(30) Foreign Application Priority Data
Sep. 5, 2006 (EP) 06018598

(51) Int. Cl. G06N 5/02

(52) U.S. Cl. 706/46

(57) ABSTRACT

The invention relates to a method for identifying an instance of a variability meta model (VMM) which models a variability in domain requirements, wherein the method comprises the steps of providing at least one set of variants (V) each describing an object of variation and having a corresponding variation point (VP) indicating a variability between said variants (V), wherein each variant (V) is connected to at least one domain requirement, generating QOC-rational model instances related to said domain requirements, deriving a justification matrix (JM) for each generated QOC-rational model instance, and generating a decision for each justification matrix (JM), wherein each decision comprises a variability link element (VLE) which is included automatically into the variability model instance. The invention further provides a method for performing a product instantiation (instantiating the instance of VMM for a specific product) by generating a QOC instance.

The invention relates to a method for identifying an instance of a variability meta-model (VMM) which models a variability in domain requirements and to a method performing a product instantiation on the basis of a variability meta-model instance.

### BACKGROUND OF THE INVENTION

Effective product family-based development depends on exploiting a communality and a variability in customary requirements. The desirability of variability in products is driven by the needs of various target market segments identified by various organisational units like sales and marketing. Variability management can be seen as a key aspect that differentiates conventional software engineering from software product line engineering. The ability in a product family can be defined as a measure of how members of a family may differ from each other. Variability is made explicit by using so-called variation points. Variation points are places in the design artefacts where a specific decision is narrowed to several options but the option to be chosen for a particular system is left open. The identification of points of variability is crucial in proliferating variety from a single product platform. The product family development process involves managing variations among different members of the family by identifying common and variable aspects in the domain under consideration.

Software product line engineering is gaining importance in the industry to overcome the complexity and variety of a product line. A particular characteristic of product line engineering is the pro-active definition of variability engineering to enable a strategic re-use of the selected variants in application engineering.

In fact many companies often produce products which form a part of a product line. Products belonging to one product line have a lot of components in common. This product line approach allows the exploitation of commonalities between different products as an additional re-use is supported. Despite commonalities products can comprise a lot of variabilities i.e. components that vary from product to product, in product lines. The main issue for product line approaches is to manage the respective variability.

A conventional variability meta-model VMM can be used to describe a variability and can serve as a basis of variability management. In requirements engineering lots of decisions are to be taken and the knowledge behind these decisions, i.e. implicit knowledge, is important, too. Rationale methods try to capture this implicit knowledge and provide argumentation-based justification of decisions. A so-called QOC-model (questions, options, and criteria) is used to capture rationale information in the form of a model.

In a conventional product line requirements engineering environment variability management is usually included, however, rationale methods which capture implicit knowledge behind decisions, which provide an argumentation-based justification of these decisions are not considered so far in this context.

### SUMMARY OF THE INVENTION

The invention provides a method for identifying an instance of a variability meta-model VMM which models a variability in domain requirements, wherein the method comprises the steps of:
(a) providing at least one set of variants V each describing an object of variation and having a corresponding variation point VP indicating a variability between said variants V,
   wherein each variant V is connected to at least one domain requirement;
(b) generating QOC-rational model instances related to said domain requirements;
(c) deriving a justification matrix for each generated QOC-rational model instance; and
(d) generating a decision for each justification matrix, wherein each decision comprises a variability link element VLE which is included automatically into the variability model instance.

In one embodiment of the method according to the present invention the variability link element is formed by an alternative choice cardinality indicating a minimum and a maximum number of selectable variants.

In one embodiment of the method according to the present invention the variability link element is formed by a constraint dependency.

In one embodiment of the method according to the present invention the variability link element is formed by a variability dependency.

In one embodiment of the method according to the present invention the constraint dependency indicates that a selection of a variation point or variant presumes the selection of another variation point or a variant prohibits the selection of another variation point or variant.

In one embodiment of the method according to the present invention the variability dependency is formed by an optional variability dependency or by a mandatory variability dependency.

In one embodiment of the method according to the present invention the generated QOC-rationale model instance comprises questions, options, criteria and arguments given by stakeholders.

In one embodiment of the method according to the present invention the derived justification matrix comprises for each combination of an option and of a criterion of the generated QOC-rationale model instance an argument indicating a justification of the respective option to fulfil the respective criterion.

In one embodiment of the method according to the present invention the justification matrix comprises a rationale for the variability link element.

In one embodiment of the method according to the present invention the criteria are formed by non-functional requirements.

The invention further provides a method for performing a product instantiation on the basis of a variability meta-model instance having variants each describing an object of variation and variation points indicating a variability between the variants,

wherein the method comprises the steps of:
(a) generating a QOC-model instance of the product by
(a1) providing a question on an instantiation for each variation point VP of the variability meta model instance;
(a2) selecting automatically a subset of variants V of the respective variation point VP depending on constraint dependencies and on variability dependencies of the variability meta model instance;
(a3) generating automatically an option for each variant V of the selected subset of said variants V;
(a4) and by eliciting criteria for the product instantiation and deriving arguments for the elicited criteria and generated options;
(b) transforming the generated QOC-model instance for the product into a corresponding justification matrix which comprises for each combination of an option and of a criterion an argument indicating a justification of the respective option to fulfil the corresponding criterion; and
(c) generating a decision for the provided question from the justification matrix,
   wherein the decision comprises instantiated variants.

In one embodiment of the method according to the present invention the criteria for the product instantiation are product specific non-functional requirements.

In one embodiment of the method according to the present invention, the QOC-model instance forms a generic way to resolve variability, i.e. to perform product instantiation.

The invention further provides an apparatus for identifying an instance of a variability meta-model which models a variability in domain requirements,

wherein the apparatus comprises:
(a) means for providing at least one set of variants each describing an object of variation and having a corresponding variation point VP indicating a variability between said variants,
   wherein each variant is connected to at least one domain requirement;
(b) means for generating QOC-rationale model instances related to said domain requirements;
(c) means for deriving a justification matrix for each generated QOC-rational model instance; and
(d) means for generating a decision for each justification matrix,
   wherein each decision comprises a variability link element which is included automatically into the variability model instance.

The invention further provides an apparatus for performing a product instantiation on the basis of a variability meta-model instance having variants each describing an object of variation and variation points indicating a variability between the variants,

wherein the apparatus comprises:
(a) means for generating a QOC-model instance of the product having:
(a1) means for providing a question on an instantiation for each variation point of the variability meta-model instance;
(a2) means for selecting automatically a sub-set of variants V of the respected variation point VP depending on constraint dependencies and on variability dependencies of the variability meta-model instance;
(a3) means for generating automatically an option for each variant V of the selected sub-set of said variants V;
(a4) and means for eliciting criteria for the product instantiation and deriving arguments for the elicited criteria and generated options;
(b) means for transforming the generated QOC-model instance for the product into a corresponding justification matrix which comprises for each combination of an option and of a criterion an argument indicating a justification of the respective option to fulfil the corresponding criterion;
(c) means for generating a decision for the provided question Q from the justification matrix,
   wherein the decision comprises instantiated variants V.

### BRIEF DESCRIPTION OF THE FIGURES

FIG. 1 shows a general variability meta-model VMM as used by the method according to the present invention;

FIG. 2 shows a QOC-rationale model as used by the method according to the present invention;

FIG. 3 shows a rationale-based variability meta-model for variability constraints as used in one embodiment of the method according to the present invention;

FIG. 4 shows a rationale-based variability meta-model for product instantiation as used in one embodiment of the method according to the present invention;

FIG. 5 shows an example for a variability model;

FIG. 6 shows an example for an instantiation of a rationale-based variability meta-model for variability constraints or constraints dependency as an instantiation of the model in FIG. 3;

FIG. 7 shows an example for an instantiation of a rationale-based variability meta-model for a variability constraints for an alternative choice as an example for the model shown in FIG. 3;

FIG. 8 shows an instantiation of a rationale-based variability meta-model for product instantiation as an instantiation of the model shown in FIG. 4.

### DETAILED DESCRIPTION OF EMBODIMENTS

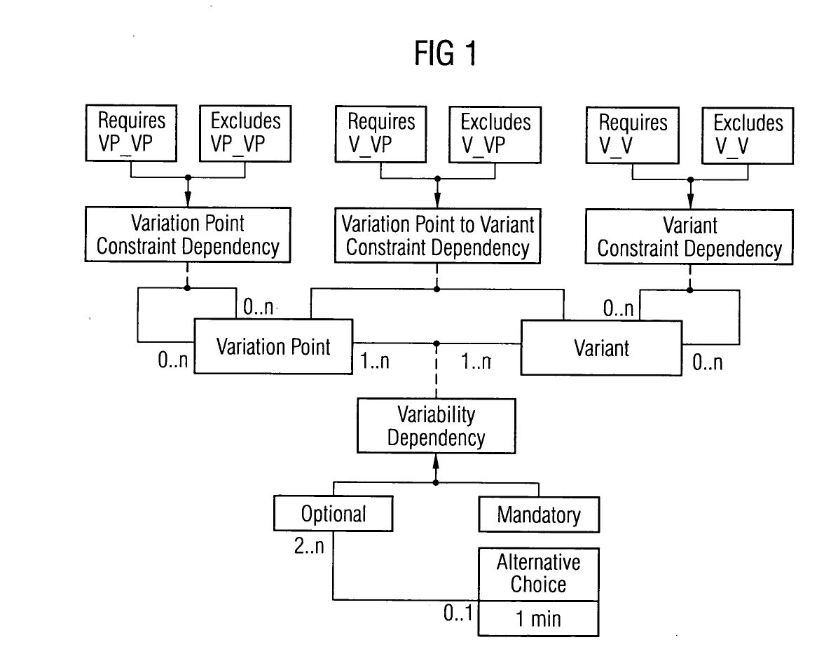

As can be seen from FIG. 1 the variability meta-model VMM as shown in FIG. 1 includes as elements a variation point VP describing a subject of variation wherein the variation point VP indicates a variability between variants V. The variation point VP captures a location and a reason of variation. Furthermore, the variability meta-model VMM includes variants V. A variant V describes an object of variation. Whereas a subject of variation is described by a variation point VP corresponding objects variation are described by variants V. Variants V capture different possibilities of variation.

A relation between a variation point VP and a variant V is called variability dependency. Variability dependency is either alternative, optional or mandatory. The optional variability dependency indicates that a variant V can be selected or left out at the variation point VP. A mandatory variability dependency indicates that a variant V has to be part of a variation point VP. An alternative choice cardinality indicates a minimum and a maximum number of selectable variants V, i.e. cardinalities show a minimum and a maximum of variants for a variation point VP which can be selected. Whereas the relation between a variation point VP and a variant V is called variability dependency the relation between two variation points VP or variants V and between a variant V a variation point VP is called a constraint dependency, because it represents possible constraints within the variability model. The selection of a variation point VP/variant V can influence the selection of another variation point VP/variant V. The constraint dependency as used in the variability meta-models VMM are “requires” and “excludes”. Accordingly, a constraint dependency either indicates that a selection of variation point VP or variant V assumes the selection of another variation point VP or variant V (“requires”) or indicates a selection of a variation point VP or a variant V prohibits the selection of another variation point VP or variant V (“excludes”). With other words the constraint dependency “requires” describes that a variant V needs another variant V or variation point VP for its realisation or that a variation point VP needs another variation point VP for its realisation. Furthermore, the constraint dependency “excludes” describes that it is not allowed to use a variant V with another variant V or variation point VP and it is not allowed to use any variant V of two variation points VP together.

Accordingly, “requires” VP_VP indicates that a variation point VP requires another variation point VP,

“requires” VP_V indicates that a variation point VP requires a variant V and

“requires” V_V indicates that a variant V requires another variant V.

The term “excludes” is used when the selection of a variation point/variant prohibits the selection of another variation point/variant i.e.

“excludes VP_VP” indicates that a variation point excludes another variation point,

“excludes VP_V” indicates that a variation point excludes a variant V and “excludes V_V” indicates that a variant excludes another variant V.

Variability modelling is based on a conventional variability meta-model VMM as shown in FIG. 1. A variability model which can represent a variability of a product line together with possible constraints between different variation points VP and variants V can be transformed to a variability meta-model VMM as shown in FIG. 1. For example, features of a product can be variation points VP as well as variants V. Features that detail another feature can be considered as a variant V. A feature that is detailed by other features can be considered a variation point VP. Definition of variation points VP and variants V in the variability model allows the explicit definition of a product line such as the product line of a car manufacturer. This enables communication about variability between engineers, customers and other stakeholders of a product line.

After organisation of core assets of a domain in form of a product line using the variability meta-model VMM as shown in FIG. 1 it is necessary to re-use them in future for each specific product. Product instantiation is the procedure of re-using core assets of a domain in the form of a product line for a specific product.

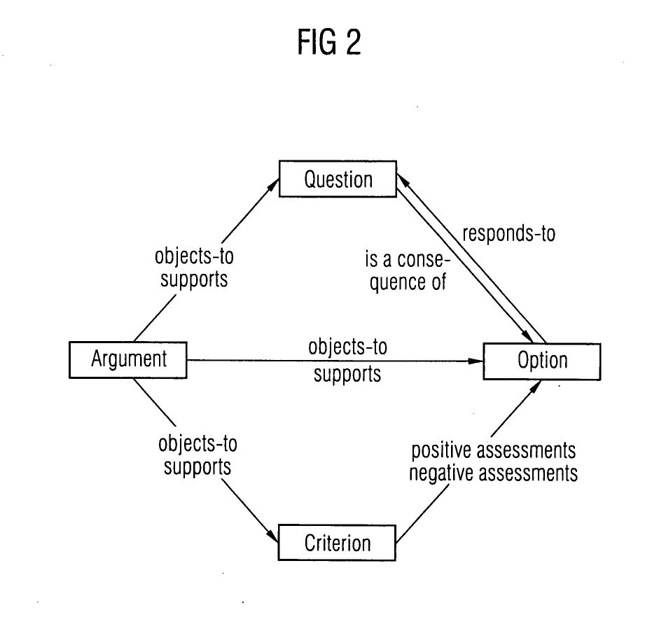

A QOC-rationale model (QOC=questions, options and criteria) captures rationale information in the form of a model. The rationale is a justification behind decisions including alternatives, evaluation of criteria, arguments and decisions. Accordingly, a QOC-model is an argumentation-based representation of rationale. Rationale is very useful for maintenance e.g. change-management, of the product lines. A QOC-rationale model using a UML class diagram is shown in FIG. 2. The QOC-model as shown in FIG. 2 comprises questions, options, criteria and arguments. Questions represent problems to be solved or a problem that needs clarification. Options represent considered alternatives for answering a question. Criteria represent qualities that are used to evaluate opinions in a certain context. Criteria provide positive or negative assessments for options. Non-functional requirements NFR are good contestants for such criteria. Rationale management forms are part of the knowledge management of the system.

The procedure of evaluating or selecting an option using argument and criteria in order to solve a question is called justification. In the justification procedure questions, options, criteria and arguments are elicited using the collaborative work of different stakeholders. For each question corresponding options, criteria and arguments are represented in the form of a justification matrix JM as shown in example tab. 1.

TABLE 1

| Critera | Criterion 1 | Criterion 2 |
|---|---|---|
| Option 1 | ++ | + |
| Option 2 | −− | − |

Table 1 as shown above has options as row annotations and criteria as column annotations. The justification matrix JM comprises for each combination of an option and of a criterion of the QOC-rationale model instance an argument indicating a justification of the respective option to fulfil the respective criterion. In Tab. 1 the arguments are represented by using “++”, “+”, “−” and “−−” wherein the arguments are input by the stakeholders, indicating justification of the respective option to fulfil the respective criterion.

For instance, “++” indicates a very high degree of fulfilment, “+” fulfilment, “−” non-fulfilment and “−−” a high degree of non-fulfilment.

In the QOC model, a question can have many options and some options are instantiated based on justification. This is similar to a variation point VP having many variants V, which need instantiation. Therefore, the QOC-model employed by the method according to the present invention models variability generically.

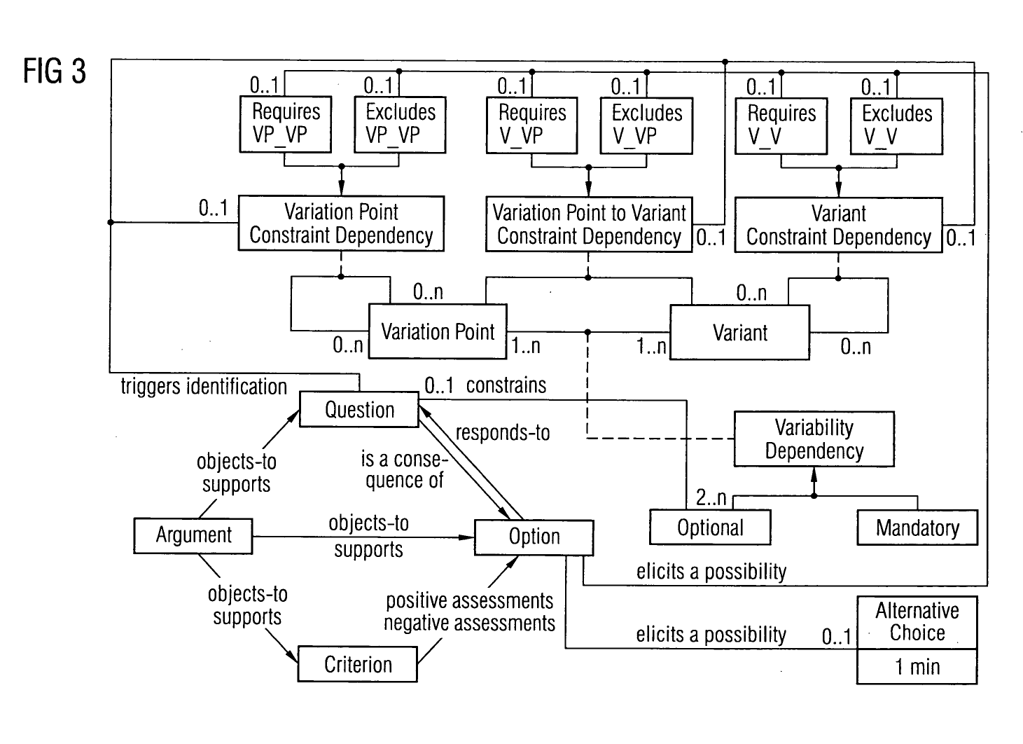

FIG. 3 shows a rational-based variability meta-model for variability constraints as used by the method according to the present invention. As can be seen from FIG. 3 the conventional rationale QOC model as shown in FIG. 2 is integrated into the variability meta-model as shown in FIG. 1 to form a rationale-based meta model for variability constraints as shown in FIG. 3. The rationale-based variability meta-model for variability constraint is formed by the integration of the QOC-model in order to solve the problems associated with variability constraints.

The rationale-based variability constraint model as shown in FIG. 3 allows elicitation and documentation of variability constraints. The classes as shown in FIG. 3, such as “Requires VP_VP”, “Requires V_VP”, “Requires V_V”, “Excludes VP_VP”, “Excludes VP_V”, “Excludes V_V” and “Alternative Choice” are concrete variability constraints in the variability meta-model VMM as shown in FIG. 1. The QOC-model and the variability meta-model VMM are linked by relationships. A question of the QOC-model is associated with “Variation Point Constraint Dependency”, “Variation Point to Constraint Dependency”, “Variant Constraint Dependency” and “Optional” classes of the variability meta-model VMM. By doing this a “question” is created on the classes of the variability model that are linked to variability constraints. Accordingly, the question triggers the identification of the variability constraints.

“Option” of the QOC-model is associated with variability constraints, such as “Requires VP_VP”, “Requires V_VP”, “Requires V_V”, “Excludes VP_VP”, “Excludes VP_V”, “Excludes V_V” and “Alternative Choice”. Each option is associated in one embodiment to only one of the variability constraints such as a 0 . . . 1 so that multiplicity is provided. These associations can be performed because as constraint dependency classes are associated with a question the possible instances of constraint dependencies such as “Requires” and “Excludes” are options. A set of optional variants V that are associated with a variation point VP can have alternative choices. As “Optional” is associated with “Question”, “Alternative Choice” is associated with “Option”.

As can be seen from the meta-model shown in FIG. 3 the association between “Option” and “Alternative choice” as shown in FIG. 1 is deleted in FIG. 3. According to the meta-model of FIG. 3 “2 to n” objects of “Optional” are associated with “o to 1” objects of “Question”, and “Option” is associated with “Alternative Choice”. Although, the QOC-model supports many options, in rationale-based variability constraints only one option among the supported options is justified. Accordingly, FIG. 3 depicts the existing association between “Optional” and “Alternative Choice” by re-directing the association through a QOC-model and therefore the direct association between “Optional” and “Alternative Choice” is not necessary.

The meta-model as shown in FIG. 3 can be operated as follows:

When modelling product lines, after identifying variation points VP and variants V, variability constraints are to be identified. The identification of a variability constraint is triggered with a question of the QOC-model.

For answering a question, corresponding options are elicited from the stakeholders as shown the FIG. 3. Further, criteria and arguments are also derived from different stakeholders involved in product line modelling.

Using a justification matrix JM for each question, the justification for variability constraints is done and the correct variability constraint is identified.

As the justification matrix JM for each variability constraint is available, they are additionally documented along with the variability constraints in order to remove ambiguity behind them.

Using the meta-model as shown in FIG. 3, reasoning and justification in form of justification matrices is captured additionally with the variability constraints. This reasoning and justification behind the variability model is useful in further activities of product line engineering like product instantiation and product line evolution.

The invention provides a method for identifying an instance variability meta-model VMM which models a variability in domain requirements. In a preferred embodiment of the method according to the present invention the method comprises several sequentional steps:

In a first step S1 at least one set of variants V, each describing an object of variation and having a corresponding variation point VP indicating a variability between that variants V is provided. Each variant V is connected to at least one domain requirement.

In a further step S2 the QOC-rationale model instances related to the domain requirements are generated.

In a further step S3 a justification matrix JM is derived for each generated QOC-rationale model instance.

In a further step S4 a decision for each justification matrix JM is generated, wherein each decision comprises a variability link element VLE, which is included automatically into the variability model instance.

The variability link element VLE is formed by an alternative choice cardinality, a constraint dependency or a variability dependency. An alternative choice cardinality indicates a minimum and a maximum of selectable variants V. Constraint dependency represent possible constraints for the variability model i.e. constraint dependency indicates that a selection of a variation point VP or variant V presumes a selection of another variation point VP or variant V or indicate that a selection of a variation point VP or variant V prohibits the selection of another variation point VP or variant V.

The variability dependency is formed either by an optional variability or by a mandatory variability dependency. The QOC-rationale model instance generated in step S2 is related to the domain requirements which are connected to each variant V and comprise questions, options, criteria and arguments given by stakeholders involved in the process.

The justification matrix JM derived in step S3 describes for each combination of an option and of a criterion of the generated QOC-rationale model instance an argument input by a stakeholder indicating a justification of the respective option to fulfil the respective criterion. The justification matrix JM comprises a rationale for the variability link element VLE. The criteria of the generated QOC-rationale model instance can be formed by non-functional requirements NFR. The justification matrices JM indicates the relationship between variability i.e. variability link element VLE, and a non-functional requirement NFR.

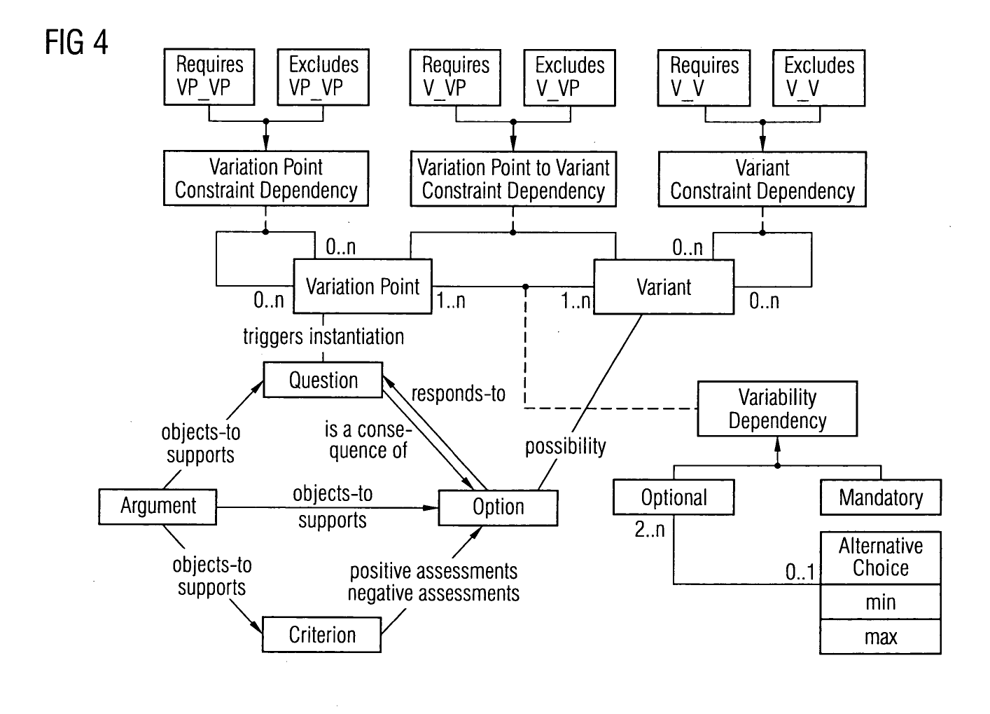

FIG. 4 shows an embodiment of a rational-based variability meta-model for product instantiation as used by the method for performing a product instantiation according to the present invention. This is done by exploiting the generic variability of the QOC-model.

As can be seen from FIG. 4 “Question” of the QOC-model is associated with “Variation Point” of the variability meta-model VMM. Accordingly, the instantiation of the variation point VP is triggered by a question. The possible optional variants that can be instantiated and which are associated to the question variation point VP for a specific application/product are QOC-options. Accordingly, in the meta-model of product instantiation “Option” class is associated with “Variant” class. The operation of the meta-model as shown in FIG. 4 is performed as following. The product instantiation is conducted for example in a product line management meeting, where all stakeholders and customers together derive a specific product from a product line.

Stakeholders identify questions and possible options for a new product that is going to be instantiated. Product specific quality concerns, such as non-functional requirements NFR, are elicited from the customers' product lines to constitute some criteria. Some criteria of the justification matrices JM of rationale-based variability constraints are re-used and constitute the remaining criteria of rationale-based product instantiation. The arguments are derived from stakeholders and the justification is performed for the derivation of a new product. The rationale-based variability meta-model for variability constraints as shown in FIG. 3 are useful for identifying and documenting the variability constraint model elements of the variability model. The rationale-based product instantiation on the basis of the rationale-based variability meta-model for product instantiation as shown in FIG. 4 is performed to instantiate variants V that are associated with a variation point VP for a specific product.

On the basis of the model shown in FIG. 4 the invention provides a method for performing a product instantiation on the basis of a variability meta-model VMM instance having variants V, each describing an object of variation and variation points VP, indicating a variability between the variants V wherein the following steps are performed:

In a first step S1 a QOC-model instance of the product is generated by performing the following sub-steps.

In a first sub-step a question on an instantiation for each variation point VP of the variability meta-model VMM instance is provided.

In a further sub-step a subset of variants V of the respective variable point VP are selected depending on constraint dependencies and on variability dependencies of the variability meta-model instance.

In a further sub-step an option is automatically generated for each variant V of the selected sub-set of said variants V.

In a further sub-step criteria for the product instantiation are elicited and arguments are derived for the elicited criteria and generated options.

After having generated the QOC-model instance for the product the generated QOC-model instance for the product is transformed in a further step into a corresponding justification matrix JM, which comprises for each combination of an option and of a criterion an argument indicating a justification of the respective option to fulfil the corresponding criterion.

In a further step the decision for the provided question is generated from the justification matrix JM, wherein the decision comprises instantiated variants V.

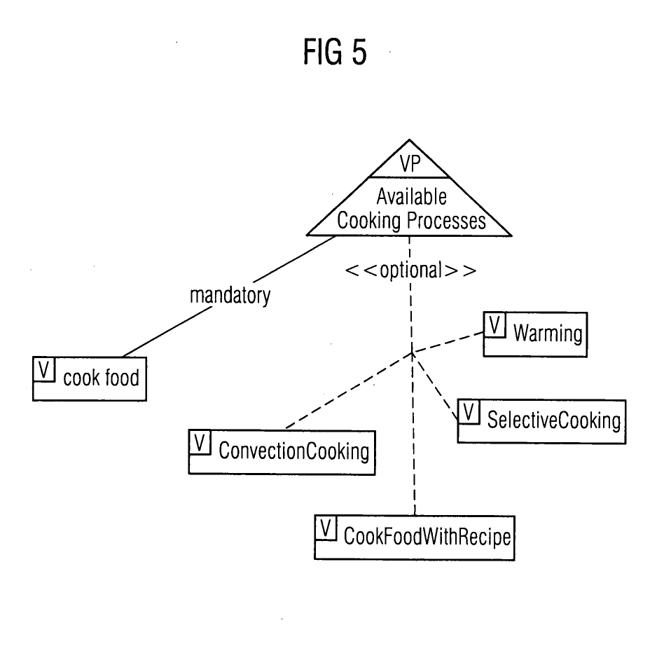

FIG. 5 shows a simple variability model using OVM notation. In the given example the product is formed by a microwave oven in the field of domestic appliances. Different microwave ovens support different types of cooking processes. Therefore, it is possible to identify a variability in cooking processes of microwave ovens. In the simple example as shown in FIG. 5 the variation point “available cooking processes” has four optional variants V like “convection cooking”, “cook food with recipe”, “selective cooking” and “warming”. The variation point VP also has a further mandatory variant such as “cook food” which is not considered in the further discussion for sake of simplicity.

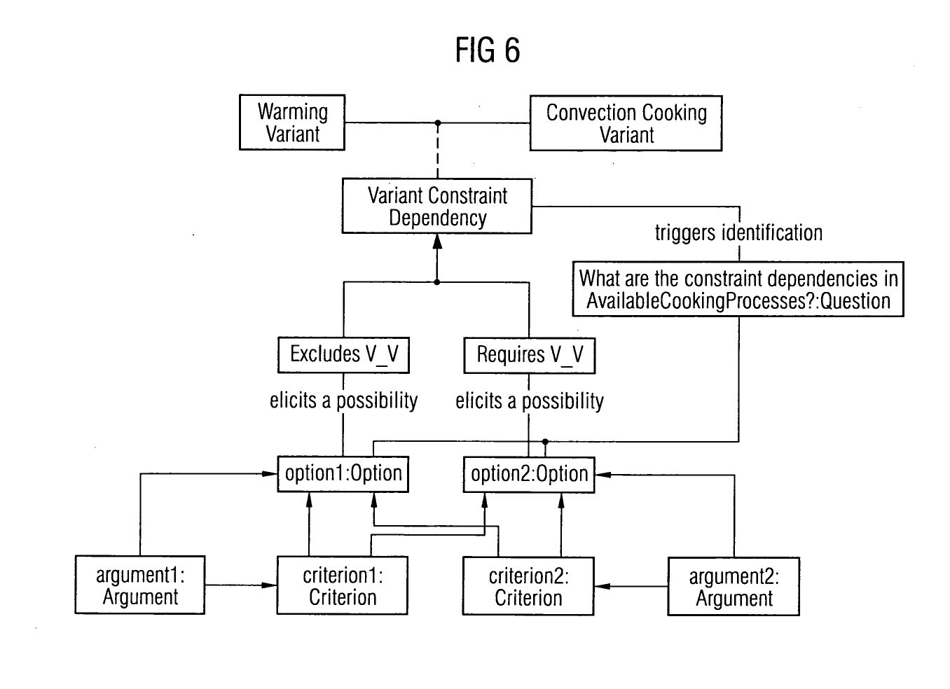

FIG. 6 shows a specific instance of the rationale-based variability meta-model VMM for variability constraints as shown in FIG. 3 for the example shown in FIG. 5.

A first stakeholder triggers the elicitation of constraint dependencies between variants V and starts the negotiations as shown in tab. 2.

TABLE 2
Stakeholder 2

| | |
|---|---|
| Question | What are the constraint dependencies in the |
| | variants related to the variation point |
| | “available cooking processes”? for e.g. |
| | “convection cooking” seems to have effect on |
| | other cooking processes. |

Stakeholder 2

| | |
|---|---|
| Option1 | We can choose only one of the convention cooking |
| | and warming (convection cooking excludes warming) |
| Argument 1 | Convection cooking and warming relies on |
| | different hardware technologies. Using both of |
| | them increases the cost of the microwave oven. |
| Criterion 1 | Optimal cost price for product: according to |
| | regulation GO304, the price of microwave ovens |
| | should not exceed 999USD. |

Stakeholder 3

| | |
|---|---|
| Option 2 | If one of the “Convection cooking and warming” |
| | cooking process is selected, the other should be |
| | selected. (“Convection cooking requires warming, |
| | and warming requires convection cooking”) |
| Argument 2 | Convection cooking and warming are advanced |
| | features as per current technologies. So keeping |
| | them in one product increases sales. This |
| | decision is taken by requirements engineering |
| | stakeholders5 |
| Criterion 2 | Boosting sales: increase of sales by attracting |
| | many customers. |

A second stakeholder and a third stakeholder give also possible options, criteria and arguments as shown in tab. 2.

The reasoning behind option 1 is described using argument 1 and criterion 1.

In a similar manner stakeholder 3 gives option 2, argument 2 and criterion 2, which are shown in tab. 2. The generated QOC-rationale model instance as shown by tab. 2 is related to the domain requirements. From the generated QOC-rationale model instance shown in table 2 a justification matrix JM is derived as shown in tab. 3 below. The justification matrix JM as shown in tab. 3 comprises for each combination of an option and of a criterion of the generated QOC-rationale model instance an argument input by a stakeholder indicating a justification of the respective option to fulfil the respective criterion. For Example a technician as a first stakeholder gives option 1 and a businessman as another stakeholder gives option 2. The argument indicating a justification of the respective option to fulfil the respective criterion, for instance, justification of the option “convection cooking excludes warming” fulfils the criterion “optimal cost price for product” (i.e. the microwave oven) is input by another stakeholder, such as the product team leader indicating that option 1 fulfils very good the respective criterion. In contrast option 2 i.e. convection cooking requires warming and warming requires convection cooking does not fulfil the respective criterion, i.e. “optimal cost price for product”. Accordingly, in possible embodiment the argument is input as a scaling factor ranging from “++” for a full fulfillment to “−−” indicating that the option does not fulfil the respective criterion at all.

TABLE 3
Justification for constraint dependency
between Convection Cooking and Warming

Critera

| | Optimal cost price | |
|---|---|---|
| | for product | Boosting sales |
| Option 1: convection | ++ | + |
| cooking excludes | | |
| warming | | |
| Option 2: convection | −− | ++ |
| cooking requires | | |
| warming & Warming | | |
| requires convection | | |
| cooking | | |

Decision: option 1 is justified, as we have a positive justification for both criteria

From the derived justification matrix JM as shown in table 3 a decision is derived which comprises the variability link element VLE which is included automatically into a variability model instance. In the given example the generated decision for action item is that “option 1 is justified since there is a positive justification for both criteria, i.e. cost price for product and boosting sales.

The action item “convection cooking excludes warming” generated as a decision is automatically included into a system model of a software engineering system. Consequently, the knowledge model, i.e. QOC-model is linked to a system model, such as the variability model, and is used for an automatic update of the variability model which forms an instance of the variability meta model VMM. Furthermore, the knowledge model, i.e. the QOC-model leads to the generation of a decision using a derived justification matrix JM. Since the justification matrix and the QOC-model are generated by stakeholders and organisations, such as an engineering company, there is also a link of the knowledge model to the organisation model such as an organisation diagram indicating the stakeholders which provide the necessary input. For instance, a product line manager responsible for the instantiated product will debate each pair of option/criterion provided by other stakeholders from other departments such as technicians or sales manager to generate a decision which leads to an automatic update of a software engineering model.

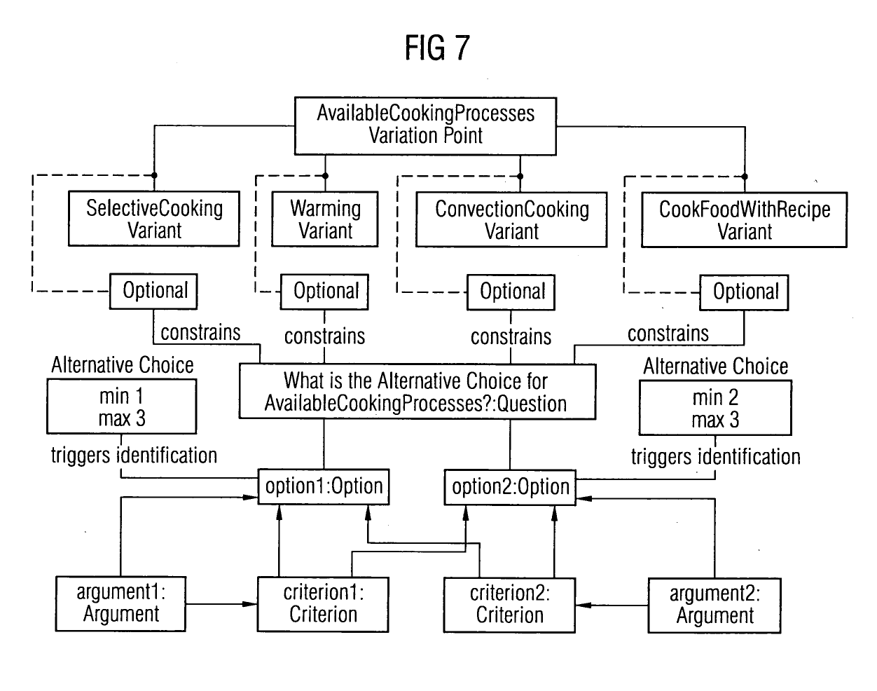

FIG. 7 shows an example of an instantiation of a rationale-based variability meta-model VMM for variability constraints for an alternative choice.

The rationale-based variability constraints can be used for the identification of an alternative choice of the “available cooking process” variation point VP. FIG. 7 shows a specific instance of a rationale-based variability meta-model for variability constraints as shown in FIG. 3 for the identification of the “available cooking process” variation point VP as shown in FIG. 5. Questions, options, criteria and important arguments in this example are shown as a QOC-model instance in table 4.

TABLE 4
Stakeholder 1

| | |
|---|---|
| Question | What is the alternative choice for available |
| | cooking processes variation point? |

Stakeholder 2

| | |
|---|---|
| Option 1 | 1 . . . 3 (minimum of 1 and a maximum of 3 variants |
| | can be selected from the available cooking |
| | processes variation point) |
| Argument 1 | The range of cooking processes (from 1 to 3) |
| | satisfies the quality of criterion 1. |
| Criterion 1 | Usability: a user of the microwave shall be able |
| | to learn 80% of ist functionalities within 8 to |
| | 12 hours. |

Stakeholder 3

| | |
|---|---|
| Option 2 | 2 . . . 3 (minimum of 2 and a maximum of 3 variants |
| | can be selected from the available cooking |
| | processes variation point) |
| Argument 2 | Some microwave ovens do not have enough memory |
| | for more than one cooking process. |
| Criterion 2 | Memory: the memory of a microwave oven range |
| | form 3 memory pads to 10 memory pads. |

The QOC-model instance of tab. 4 is transformed into a justification matrix JM for the alternative choice as shown in tab. 5

TABLE 5
Justification for the alternative choice of the
available cooking process variation point

| Criteria | Usability | Memory |
|---|---|---|
| Option 1: 1 . . . 3 | ++ | + |
| Option 2: 2 . . . 3 | − | − |

Decision: option 1 is justified, because of positives in both the criteria.

In the given example using the shown justification matrix JM option 1 (1 . . . 3) is selected as an alternative choice of the “available cooking process” variation point VP.

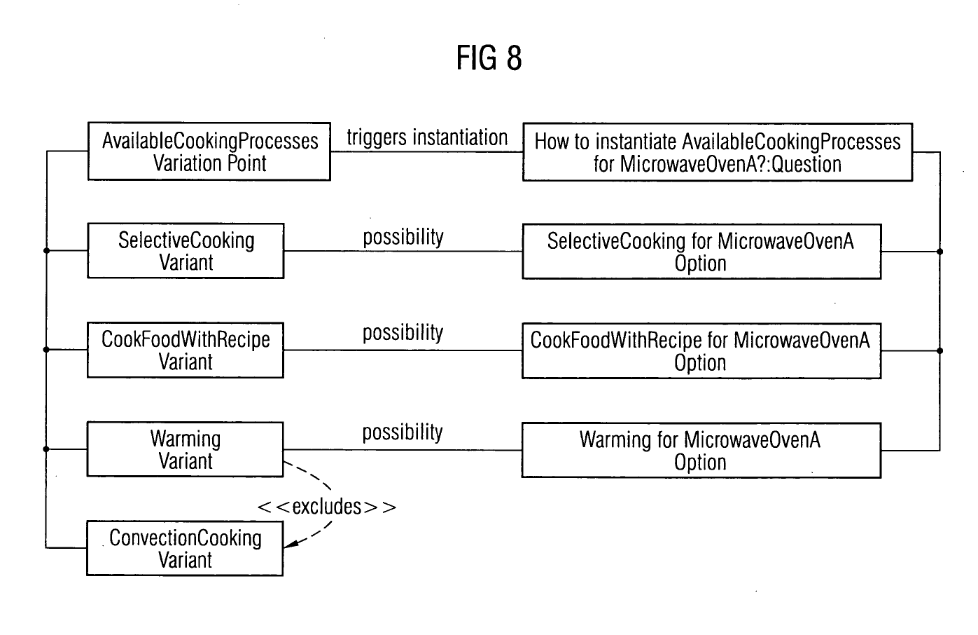

FIG. 8 shows a specific instance of a rationale-based variability meta-model for product instantiation as shown in FIG. 4 for the instantiation of “available cooking process” variation point VP as shown in FIG. 5. In this example optional variants of “available cooking processes” variation point VP are instantiated for a new application “microwave oven”.

Tab. 6 shows the elicitation of knowledge from stakeholders for the instantiation of “available cooking processes”.

TABLE 6

| | |
|---|---|
| Question | How to instantiate “available cooking processes” |
| | variation point for microwave oven A? |
| Option 1 | Selective cooking is selected for microwave oven A |
| Option 2 | Cook food with recipe is selected for microwave oven A |
| Option 3 | Warming is selcted for microwave oven A |
| Criterion 1 | Response time: the cooking processes of the |
| | microwave oven shall respond within 0.1 seconds |
| Criterion 2 | Usability: a user of the microwave shall be able to |
| | learn 80% of ist functionalities within 9 hours |
| Criterion 3 | Memory: the memory of the microwave oven constitutes |
| | 6 memory pads |
| Criterion 4 | Reliability: the microwave oven shall be operated |
| | within the rate of 0.008 errors/hour. |
| Argument 2 | Selective cooking objects-to microwave oven A, |
| | because it contradicts the usability requirement as |
| | described the criterion 2. |
| Argument 10 | Warming supports microwave oven A, because it needs |
| | less memory. |

FIG. 8 shows an instantiation of the variation model instance as shown in FIG. 4. This instantiation can be conducted in a product line management meeting where different stakeholders like product line managers, domain requirement engineers and customers tend to derive reuse requirements using variability models based on the needs of customers for products such as microwave ovens.

The stakeholders identify critical variation points VP which need interactive decision making in order to instantiate them. In the above example “available cooking processes” is a critical variation point VP.

On a basis of a variability model the stakeholders identify a question and possible options. In the given example question and possible options are shown in the tab. 6.

In the given example non-functional requirements NFRs which are elicited from the customers such as “response time” shown in tab. 6 and which constitute product specific criteria and product line specific criteria such as “usability” and “memory” tab. 6 are re-used from tab. 5.

The arguments are derived by the collective work of the stakeholders and a justification matrix JM is generated as shown in tab. 7.

TABLE 7
Justification: instantiation of available cooking
process variation point for the microwave oven A

| | Criteria | | | |
|---|---|---|---|---|
| | Response | | | |
| | time | Usability | Memory | Reliability |
| Option 1: | − | −− | + | + |
| selective | | | | |
| cooking | | | | |
| Option 2: | + | ++ | + | + |
| cook food | | | | |
| with recipe | | | | |
| Option 3: | + | + | ++ | + |
| warming | | | | |

Decision:
cook food with recipe is selected because of better response time and usability, when compared to selective cooking
warming is selected as it has plus points in all its criteria

In on the generated justification matrix “cook food with recipe” and “warming” are optional variants of “available cooking process” variation point VP that are instantiated for the microwave oven. Similar to FIGS. 6 and 7, in FIG. 8 the objects of “option” are connected to the objects of “argument” and “criterion”. In the given example there are four criteria and twelve arguments which are not shown in the instance diagram for the sake of simplicity. By using the rationale-based product instantiation method it is possible to perform interactive decision making in the context of product instantiation. In the given example using collective work of different stakeholders the method according to the present invention instantiates the “available cooking processes” variation point VP for a microwave oven product.

Each product has different quality concerns, i.e. functional requirements like response/time, usability, reliability and memory as indicated in tab. 7. Using the method according to the present invention it is possible to connect product specific non-functional requirements NFRs to an instantiated product and consequently handle the effects of non-functional requirements NFR on product instantiation.

Although product lines do not always have enough information for product instantiation it is possible with the method according to the present invention to add external knowledge using “arguments” and “criteria”.

Furthermore, some rationale information from rationale-based variability constraints are reused for rationale-based product instantiation, so that the product instantiation is made much easier. In the given example, criteria such as “memory” and “usability” are reused from tab. 5.

The method and apparatus according to the present invention provides several advantages. After constructing a product line the product line may live only for a particular period. If the product line is not further prosecuted it is very difficult to change product line models due to lack of reasoning behind them. As rational methods give reasoning and justification for variability it is possible with the method according to the present invention to change product line models. Accordingly the method according to the present invention can improve a life span of a product line and thus safe money.

The variability constraints restrict a possible combination of products that can be derived from product lines. With the method according to the present invention it is possible to elicit constraints so that product instantiation becomes easier. With the method according to the present invention faulty components can be reduced. In requirement engineering most of the stakeholders have a business related education and do not have a good technical knowledge of software engineering. The method according to the present invention has the further advantage that it focuses on matrix based presentations such as a justification matrix JM. Accordingly, the usability of the method according to the present invention is high.

The variability constraints in product line requirement engineering originate from the decisions of stakeholders from different departments such as business, marketing, legal issues, standardisation, technology and NFRs. As these aspects originate from knowledge within the stakeholders a rational management as used by the method according to the present invention enhances the success of product line requirements engineering. Furthermore, the method according to the present invention improves the collaboration between different stakeholders in product line requirements engineering and provides a basis for interactive decision making.

The method according to the present invention uses rationale models for product line requirements engineering. The method according to the present invention which identifies a variability link element VLE and additionally captures rationale is useful particularly for the maintenance e.g. change management, of the product line. The QOC-model according to the method according the present invention comprises a generic variability. The QOC-model instance, i.e. questions and criteria, which are employed by the method according to the present invention are contributed by various stakeholders which may sit in different countries or even continents and thus enable global product line requirements engineering.

This application claims benefit under 35 U.S.C. § 119 to European Patent Application No. 06018598, filed on Sep. 5, 2006 in the European Patent Office, the disclosure of which is incorporated herein in its entirety by reference.

1. A method for identifying an instance of a variability meta model (VMM) which models a variability in domain requirements,
wherein the method comprises the steps of:
(a) providing at least one set of variants (V) each describing an object of variation and having a corresponding variation point (VP) indicating a variability between said variants (V),
wherein each variant (V) is connected to at least one domain requirement;
(b) generating QOC-rational model instances related to said domain requirements;
(c) deriving a justification matrix (JM) for each generated QOC-rational model instance; and
(d) generating a decision for each justification matrix (JM),
wherein each decision comprises a variability link element (VLE) which is included automatically into the variability model instance.

2. The method according to claim 1,
wherein the variability link element (VLE) is formed by an alternative choice cardinality indicating a minimum and a maximum number of selectable variants (V).

3. The method according to claim 1,
wherein the variability link element (VLE) is formed by a constraint dependency.

4. The method according to claim 1,
wherein the variability link element (VLE) is formed by a variability dependency.

5. The method according to claim 3,
wherein the constraint dependency indicates that a selection of a variation point (VP) or a variant (V) presumes the selection of another variation point (VP) or a variant (V) or indicates that a selection of a variation point (VP) or a variant (V) prohibits the selection of another variation point (VP) or variant (V).

6. The method according to claim 4,
wherein the variability dependency is formed by an optional variability dependency or by a mandatory variability dependency.

7. The method according to claim 1,
wherein the generated QOC-rational model instance comprises questions, options, criteria and arguments given by stakeholders.

8. The method according to claim 1,
wherein the derived justification matrix (JM) comprises for each combination of an option and of a criterion of the generated QOC-rational model instance an argument indicating a justification of the respective option to fulfil the respective criterion.

9. The method according to claim 1,
wherein the justification matrix comprises a rational for the variability link element (VLE).

10. The method according to claim 7,
wherein the criteria are non-functional requirements (NFR).

11. A method for performing a product instantiation on the basis of a variability meta model instance having variants (V) each describing an object of variation and variation points (VP) indicating a variability between the variants (V),
wherein said method comprises the steps of:
(a) generating a QOC-model instance of the product by
(a1) providing a question on an instantiation for each variation point (VP) of the variability meta model instance;
(a2) selecting automatically a subset of variants (V) of the respective variation point (VP) depending on constraint dependencies and on variability dependencies of the variability meta model instance;
(a3) generating automatically an option for each variant (V) of the selected subset of said variants (V);
(a4) and by eliciting criteria for the product instantiation and deriving arguments for the elicited criteria and generated options;
(b) transforming the generated QOC-model instance for the product into a corresponding justification matrix (JM) which comprises for each combination of an option and of a criterion an argument indicating a justification of the respective option to fulfil the corresponding criterion; and
(c) generating a decision for the provided question (Q) from the justification matrix (JM),
wherein the decision comprises instantiated variants (V).

12. A Method according to claim 11,
wherein the criteria for the product instantiation are product specific non-functional requirements (NFR).

13. An apparatus identifying an instance of a variability meta-model (VMM) which models a variabilty in domain requirements,
wherein said apparatus comprises:
(a) means for providing at least one set of variants (V) each describing an object of variation having a corresponding variation point (VP) indicating a variability between said variants (V),
wherein each variant (V) is connected to at least one domain requirement;
(b) means for generating QOC-rationale model instances is related to said domain requirements;
(c) means for deriving a justification matrix (JM) for each generated QOC-rational model instance; and
(d) means for generating a decision for each justification matrix (JM),
wherein each decision comprises a variability link element (VLE) which is included automatically into the variability model instance.

14. An apparatus for performing a product instantiation on the basis of a variability model instance having variants (V) each describing an object of variation and variation points (VP) indicating a variability between the variants (V), wherein said apparatus comprises:
(d) means for generating a QOC-model instance of the product having:
(a1) means for providing a question on an instantiation for each variation point (VP) of the variability meta-model instance;
(a2) means for selecting automatically a sub-set of variants (V) of the respective variation point (VP) depending on constraint dependencies and on variability dependencies of the variability meta-model instance;
(a3) means for generating automatically an option for each variant (V) of the selected sub-set of said variants (V);
(a4) and means for eliciting criteria for the product instantiation and deriving arguments for the elicited criteria and generated options;
(e) means for transforming the generated QOC-model instance for the product into a corresponding justification matrix (JM) which comprises for each combination of an option and of a criterion an argument indicating a justification of the respective option to fulfil the corresponding criterion;
(f) means for generating a decision for the provided question (Q) from the justification matrix (JM),
wherein the decision comprises instantiated variants (V).
